(19) United States
(12) Patent Application Publication
(10) Pub. No.: US 2026/0370947 A1
(43) Pub. Date: Nov. 19, 2026

(54) VIEWING ANGLE ADJUSTMENT MECHANISM AND CAMERA ASSEMBLY

(71) Applicant: SHARETRONIC DATA TECHNOLOGY CO., LTD., Shenzhen City (CN)

(72) Inventors: Kangming GENG, Shenzhen City (CN); Zhou YI, Shenzhen City (CN); Zhaotian QU, Shenzhen City (CN); Jianfei LIU, Shenzhen City (CN)

(21) Appl. No.: 19/317,858

(22) Filed: Sep. 3, 2025

(30) Foreign Application Priority Data
May 19, 2025 (CN) 202520984039.5

(51) Int. Cl. H04N 23/695; H04N 23/51; H04N 23/54

(52) U.S. Cl. CPC H04N 23/695; H04N 23/51; H04N 23/54

(57) ABSTRACT

The present disclosure provides a viewing angle adjustment mechanism and camera assembly. The adjustment mechanism includes a support member, a camera structure and a rotating member. The support member includes a first and second connecting parts. The rotating member includes a rotating body, a third and fourth connecting parts. The third and fourth connecting parts are located on the rotating body separately. The third connecting part is rotatably connected to the first connecting part. The fourth connecting part is rotatably connected to the second connecting part. A rotation center line of the first and third connecting parts coincides with that of the second and fourth connecting part. The camera structure is fixedly connected to the rotating body. A rotation of the rotating body relative to the support member drives the camera structure to rotate relative to the support member, to change a viewing angle of the camera structure.

### CROSS-REFERENCE TO RELATED APPLICATIONS

This application claims priority under 35 U.S.C. § 119(a) to Chinese Application Patent Application No. 202520984039.5, filed on May 19, 2025, the entire disclosure of which is hereby incorporated by reference.

### TECHNICAL FIELD

The present disclosure relates to camera technology, and in particular relates to a viewing angle adjustment mechanism and camera assembly.

### BACKGROUND

Traditional cameras are mostly mounted in a fixed manner. Once mounted, their monitoring angle is determined and difficult to adjust flexibly according to actual needs.

### SUMMARY

To solve above technical problem, embodiments of the present disclosure provide a viewing angle adjustment mechanism and camera assembly, which is capable of adjusting the viewing angle of the camera without changing the mounting position of the camera to accommodate different monitoring needs.

A first aspect of the present disclosure provides a viewing angle adjustment mechanism. The viewing angle adjustment mechanism can include a support member, a camera structure and a rotating member. The support member can include a first connecting part and a second connecting part apart from each other. The rotating member can include a rotating body, a third connecting part and a fourth connecting part. The third connecting part and the fourth connecting part are located on the rotating body separately. The third connecting part is rotatably connected to the first connecting part. The fourth connecting part is rotatably connected to the second connecting part. A rotation center line of the first connecting part and the third connecting part coincides with a rotation center line of the second connecting part and the fourth connecting part. The camera structure is fixedly connected to the rotating body. A rotation of the rotating body relative to the support member drives the camera structure to rotate relative to the support member, to change a viewing angle of the camera structure.

A second aspect of the present disclosure provides a camera assembly. The camera assembly can include the viewing angle adjustment mechanism as provided in the first aspect.

The viewing angle adjustment mechanism and the camera assembly provided in the present disclosure, by setting the rotating member fixedly connected to the camera structure, and the rotating member rotatably connected to the support member, the rotation of rotating member can drive the camera structure to rotate, thereby adjusting a viewing angle of the camera structure. As a result, the camera assembly can flexibly adjust its shooting viewing angle according to monitoring needs.

### BRIEF DESCRIPTION OF THE ACCOMPANYING DRAWINGS

To describe the technology solutions in the embodiments of the present disclosure more clearly, the following briefly introduces the accompanying drawings required for describing the embodiments. Obviously, the accompanying drawings in the following description show merely at least one embodiment of the present disclosure, those of ordinary skilled in the art may also obtain other drawings based on these drawings without any creative efforts.

FIG. 1 illustrates a schematic structural view of a viewing angle adjustment mechanism in accordance with at least one embodiment of the present disclosure from first view.

FIG. 2 illustrates an exploded view of the viewing angle adjustment mechanism as shown in FIG. 1 from one view.

FIG. 3 illustrates an exploded view of the viewing angle adjustment mechanism as shown in FIG. 1 from another view.

FIG. 4 illustrates a schematic structural view of a rotating member as shown in FIGS. 2 and 3.

FIG. 5 illustrates a side view of a partial structure of the rotating member as shown in FIGS. 2 and 3.

FIG. 6 illustrates a bottom view of a partial structure of the rotating member as shown in FIGS. 2 and 3.

FIG. 7 illustrates a schematic view of a support member shown in FIG. 1 from one view.

FIG. 8 illustrates a schematic view of a partial cross-sectional structure of the viewing angle adjustment mechanism as shown in FIG. 1 take along a line I-I′.

FIG. 9 illustrates a schematic view of a support member shown in FIG. 1 from another view.

FIG. 10 illustrates a schematic structural view of a second engagement part as shown in FIGS. 2 and 3.

FIG. 11 illustrates a schematic view of another partial cross-sectional structure of the viewing angle adjustment mechanism as shown in FIG. 1 take along a line I-I′.

FIG. 12 illustrates a top view of the support member as shown in FIG. 1.

FIG. 13 illustrates a schematic view of projections of a first stop portion, a second stop portion, a rotation center line, a plate body, a side wall, and a third connecting part on a rotation plane in at least one embodiment of the present disclosure.

FIG. 14 illustrates a schematic structural view of the viewing angle adjustment mechanism as shown in FIG. 1 from second view.

FIG. 15 illustrates a schematic structural view of the viewing angle adjustment mechanism as shown in FIG. 1 from third view.

FIG. 16 illustrates a structural block view of the camera assembly in accordance with at least one embodiment of the present disclosure.

The reference numbers in the detailed description are as follows: 100—viewing angle adjustment mechanism; 10—support member; 20—camera structure; 30—rotating member; 11—first connecting part; 12—second connecting part; 31—rotating body; 32—third connecting part; 33—fourth connecting part; CL—rotation center line; 311—plate body; A—first side; B—second side; 313—first mounting post; 13—support body; 11a—first shaft part; 32a—first shaft hole; 121—third shaft part; 331—first engagement part; 332—second engagement part; 331a—first arc-shaped groove; 332—second arc-shaped groove; 33a—annular cavity 33a; 3321—main part; 3322—mounting part; 314—second mounting post; 1211—shaft body; 1212—positioning part; side wall—312; 3121—first side wall; 3122—second side wall; 3123—first notch; 3124—second notch; 14—stop portion; 141—first stop portion; 142—second portion; 141′—first projection; 142′—second projection; CL′—third projection; 311′—fourth projection; 312′—fifth projection; 32′—sixth projection; A1—seventh projection; A2—eighth projection; 311a—through hole; 131—first cover plate; 132—second cover plate; 133—side plate; 134—receiving space; 1311—opening; 21—imaging acquisition end; 200—camera assembly.

### DETAILED DESCRIPTION OF ILLUSTRATED EMBODIMENTS

In order to enable those skilled in the technical field to better understand the solutions of the present disclosure, the technical solutions in the embodiments of the present disclosure will be described clearly and completely in the following with reference to the accompanying drawings in the embodiments of the present disclosure. Obviously, the described embodiments are only a part of the embodiments of the present disclosure, rather than all of them. Based on the embodiments in the the present disclosure, all other embodiments obtained by those of ordinary skill in the art without creative efforts shall fall within the protection scope of the present disclosure.

It should be understood that the terms “first”, “second”, etc. in the specification and claims of the present disclosure and the accompanying drawings are configured to distinguish different objects and are not configured to describe a particular order. In addition, the terms “include”, “include” and “have”, and any variations thereof, are intended to cover non-exclusive inclusion. For example, a process, method, system, product or device including a series of steps or units is not limited to the listed steps or units, but optionally also can include steps or units that are not listed, or optionally can include other steps or units that are inherent to the process, method, product or apparatus. “Embodiments” in the present disclosure means that particular features, structures, or characteristics described with reference to the embodiments may be included in at least one embodiment of the present disclosure. The presence of the phrase at various places in the specification does not necessarily referring to the same embodiment, nor is it a separate or alternative embodiment that is mutually exclusive of other embodiments. It is understood by those skilled in the art, both explicitly and implicitly, that the embodiments described in the present disclosure may be combined with other embodiments.

It should be noted that the illustrations provided in the embodiments of the present disclosure are only intended to schematically explain the basic concept of the present disclosure. The drawings show only the components relevant to the present disclosure and are not drawn according to the actual number, shape, or dimensions of the components during implementation. In actual implementation, the type, quantity, and proportion of the components may vary arbitrarily, and the layout of the components may also be more complex.

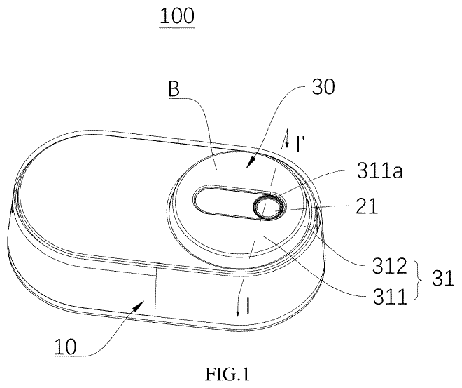

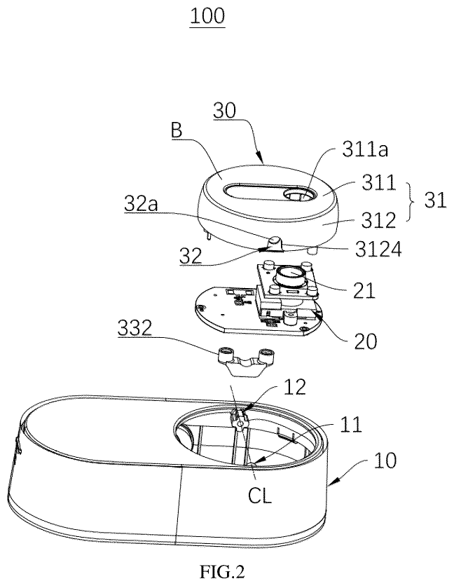

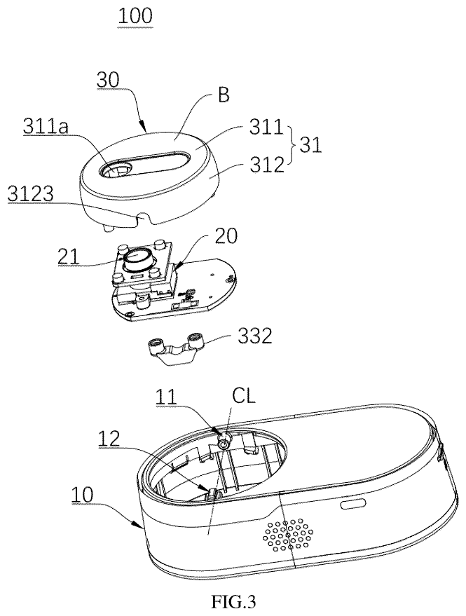

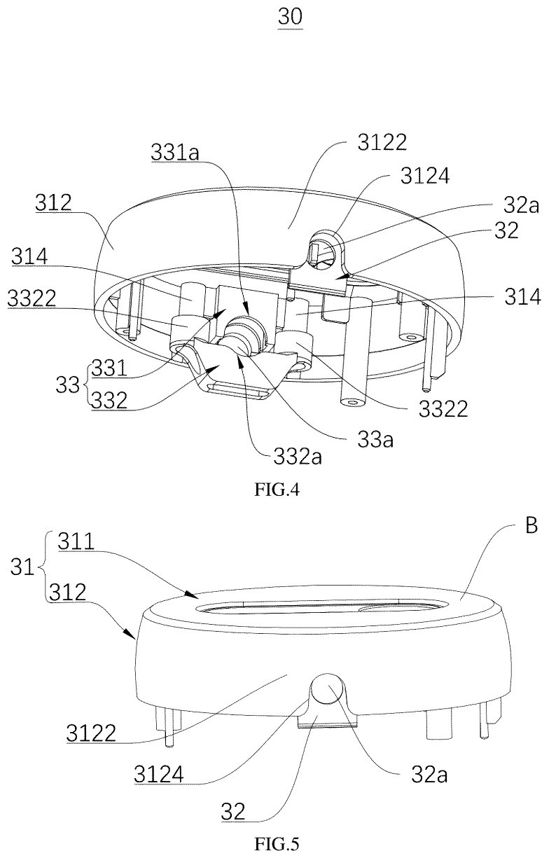

Please refer to FIGS. 1 to 4. FIG. 1 illustrates a schematic structural view of a viewing angle adjustment mechanism 100 in accordance with at least one embodiment of the present disclosure from first view. FIG. 2 illustrates an exploded view of the viewing angle adjustment mechanism 100 as shown in FIG. 1 from one view. FIG. 3 illustrates an exploded view of the viewing angle adjustment mechanism 100 as shown in FIG. 1 from another view. FIG. 4 illustrates a schematic structural view of a rotating member 30 as shown in FIGS. 2 and 3. As shown in FIGS. 1 to 2, the viewing angle adjustment mechanism 100 can include a support member 10, a camera structure 20 and a rotating member 30. The support member 10 can include a first connecting part 11 and a second connecting part 12 apart from each other. The rotating member 30 can include a rotating body 31, a third connecting part 32 and a fourth connecting part 33. The third connecting part 32 and the fourth connecting part 33 are located on the rotating body 31 separately. The third connecting part 32 is rotatably connected to the first connecting part 11. The fourth connecting part 33 is rotatably connected to the second connecting part 12. A rotation center line CL of the first connecting part 11 and the third connecting part 32 coincides with a rotation center line CL of the second connecting part 12 and the fourth connecting part 33. The camera structure 20 is fixedly connected to the rotating body 31. A rotation of the rotating body 31 relative to the support member 10 drives the camera structure 20 to rotate relative to the support member 10, so as to changing a viewing angle of the camera structure 20.

Here, the first connecting part 11, the second connecting part 12, the third connecting part 32, and the fourth connecting part 33 can all rotate around the rotation center line CL.

The viewing angle adjustment mechanism 100 provided in the present disclosure, by setting the rotating member 30 fixedly connected to the camera structure 20, and the rotating member 30 rotatably connected to the support member 10, the rotation of rotating member 30 can drive the camera structure 20 to rotate, thereby adjusting a viewing angle of the camera structure 20.

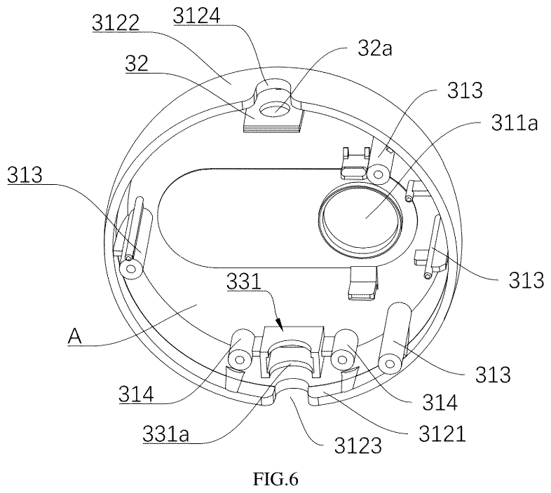

Please refer to FIGS. 1 to 6. FIG. 5 illustrates a side view of a partial structure of the rotating member 30 as shown in FIGS. 2 and 3. FIG. 6 illustrates a bottom view of a partial structure of the rotating member 30 as shown in FIGS. 2 and 3. In at least one embodiment, as shown in FIGS. 1 to 6, the rotating body 31 may include a plate body 311. The third connecting part 32 and the fourth connecting part 33 are located on a first side A of the plate body 311 along a thickness direction of the plate body 311. The camera structure 20 is located on the first side A of the plate body 311 and is fixedly connected to the plate body 311. A surface of a second side B of the plate body 311 is configured to be pressed to rotate the plate body 311 relative to the support member 10, thereby driving the camera structure 20 to rotate relative to the support member 10. The second side B is opposite to the first side A.

Here, by arranging the third connecting part 32, the fourth connecting part 33, and the camera structure 20 on the first side A of the plate body 311, the space occupied by the viewing angle adjustment mechanism 100 can be reduced. Additionally, pressing the second side B of the plate body 311 enables to rotate the rotating member 30, so as to further rotate the camera structure 20, making the adjustment of the shooting angle very convenient.

In at least one embodiment, as shown in FIG. 6, the first side A of the plate body 311 may include at least one first mounting post 313. Each first mounting post 313 extends in a direction perpendicular to the plate body 311, and each first mounting post 313 defines a screw hole. The camera structure 20 may include a lens and a circuit board connected to each other, where the circuit board defines at least one screw hole. By fastening screws into the screw hole of the first mounting post 313 and the screw hole of circuit board, the first mounting post 313 and the camera structure 20 can be securely locked, thereby fixing the camera structure 20 to the plate body 311.

Here, the camera structure 20 can be fixedly connected to the plate body 311 through screw connection, riveting, snap-fit, adhesion, or other methods.

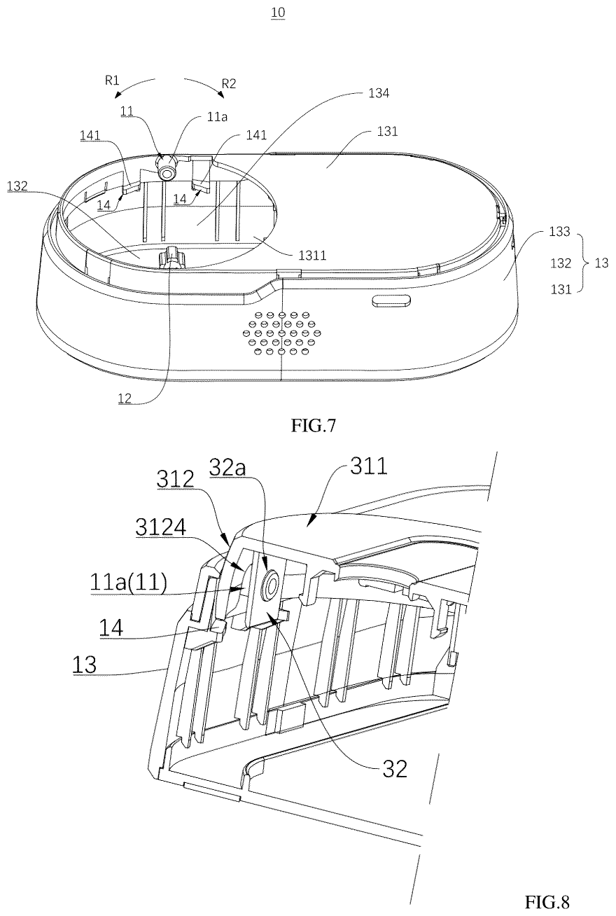

Please refer to FIG. 7. FIG. 7 illustrates a schematic view of a support member 10 shown in FIG. 1 from one view. In at least one embodiment, as shown in FIG. 7, the support member 10 may further include a support body 13, and the first connecting part 11 may include a first shaft portion 11a located on the support body 13. As shown in FIGS. 2 to 6, the third connecting part 32 defines a first shaft hole 32a. The first shaft portion 11a is inserted into the first shaft hole 32a and can rotate within the first shaft hole 32a. Alternatively, a surface of the third connecting part 32 close to the support body 13 defines a first groove, and the first shaft portion 11a is inserted into the first groove and can rotate within the first groove. The first shaft portion 11a and the first shaft hole 32a or the first groove may have a clearance fit to facilitate the rotation of the first shaft portion 11a within the first shaft hole 32a or the first groove.

Please refer to FIG. 8. FIG. 8 illustrates a schematic view of a partial cross-sectional structure of the viewing angle adjustment mechanism 100 as shown in FIG. 1 take along a line I-I′. FIG. 8 illustrates the connection relationship between the first connecting part 11 and the third connecting part 32 in at least one embodiment. In at least one embodiment, as shown in FIG. 8, the first connecting part 11 is the first shaft portion 11a, and the third connecting part 32 defines first shaft hole 32a. The first shaft portion 11a is inserted into the first shaft hole 32a.

Here, the rotation center line CL of the first shaft portion 11a and the third connecting part 32 is the central axis of the first shaft portion 11a. The central axis of the first shaft portion 11a passes through the center of the first shaft hole 32a or the center of the first groove.

An axial direction of the first shaft portion 11a may be substantially parallel to a large surface of the plate body 311, meaning that the axial direction of the first shaft portion 11a can be completely parallel or slightly inclined to the large surface of the plate body 311. That is, an angle between the axial direction of the first shaft portion 11a and the large surface of the plate body 311 is greater than or equal to 0° and less than or equal to a preset angle, for example, the preset angle may be 10°-15°. The large surface of the plate body 311 refers to a surface with a largest area of the plate body 311.

Here, the first shaft portion 11a and the support body 13 may be integrally formed or fixedly connected by screwing, riveting, snapping, bonding, welding, etc.

In other embodiments, the first connecting part 11 is a second shaft hole defined the support body 13 or a second groove defined on a surface of the support body 13 close to the third connecting part 32. The third connecting part 32 may include a second shaft portion. The second shaft portion is inserted into the second shaft hole or the second groove and can rotate within the second shaft hole or the second groove. The second shaft portion and the second shaft hole or the second groove may have a clearance fit to facilitate the rotation of the second shaft portion within the second shaft hole or the second groove.

Here, an axial direction of the second shaft portion may be substantially parallel to the large surface of the plate body 311, meaning that the axial direction of the second shaft portion can be completely parallel or slightly inclined to the large surface of the plate body 311. That is, an angle between the axial direction of the second shaft portion and the large surface of the plate body 311 is greater than or equal to 0° and less than or equal to a preset angle, for example, the preset angle may be 10°-15°.

Here, the second shaft portion and the plate body 311 may be integrally formed or fixedly connected by screwing, riveting, snapping, bonding, welding, etc.

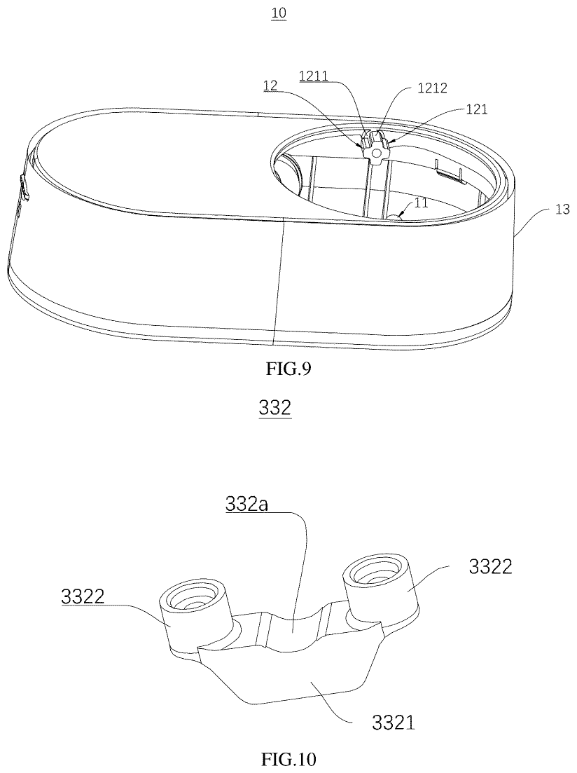

Please refer to FIG. 9. FIG. 9 illustrates a schematic view of a support member 10 shown in FIG. 1 from another view. In at least one embodiment, as shown in FIG. 9, the second connecting part 12 may include a third shaft portion 121 located on the support body 13. Please refer to FIGS. 4 and 10. FIG. 10 illustrates a schematic structural view of a second engagement part 332 as shown in FIGS. 2 and 3. As shown in FIGS. 4 and 10, the fourth connecting part 33 may include a first engagement part 331 and a second engagement part 332. The first engagement part 331 and the second engagement part 332 are fixedly connected to the first side A of the plate body 311. A surface of the first engagement part 331 away from the plate body 311 is recessed toward the plate body 311 to form a first arc-shaped groove 331a. A surface of the second engagement part 332 facing the plate body 311 is recessed away from the plate body 311 to form a second arc-shaped groove 332a. The second arc-shaped groove 332a is located on one side of the first arc-shaped groove 331a away from the plate body 311. Groove walls of the first arc-shaped groove 331a and the second arc-shaped groove 332a cooperatively form an annular cavity 33a. The third shaft portion 121 is inserted into the annular cavity 33a and can rotate relative to the first engagement part 331 and the second engagement part 332 around the axis of the third shaft portion 121. The annular cavity 33a may be a closed ring or an open ring. The third shaft portion 121 is in contact with the cavity walls of the annular cavity 33a.

The tight fit between the first engagement part 331 and the second engagement part 332 can increase a damping force when the first engagement part 331 and the second engagement part 332 rotate relative to the third shaft part 121, ensuring resistance during rotation. After the external force is removed, the constraint and the damping effect of the annular cavity 33a together enable the first engagement part 331 and the second engagement part 332 to achieve self-locking after rotation, stabilizing the angle between the plate body 311 and the support member 10.

The rotation center line CL of the third shaft portion 121 and the fourth connecting part 33 is the central axis of the third shaft portion 121, and the central axis of the third shaft part 121 passes through the center of the annular cavity 33a.

An axial direction of the third shaft portion 121 may be substantially parallel to the large surface of the plate body 311, meaning that the axial direction of the third shaft portion 121 can be completely parallel or slightly inclined to the large surface of the plate body 311. That is, the angle between the axial direction of the first shaft portion 11a and the large surface of the plate body 311 is greater than or equal to 0° and less than or equal to a preset angle, for example, the preset angle may be 10°-15°.

In at least one embodiment, as shown in FIGS. 4 and 10, the second engagement part 332 may includes a main part 3321 and at least one mounting part 3322 connected to each other. The at least one mounting part 3322 is fixedly connected to the plate body 311, thereby fixing the main part 3321 to the plate body 311. The main part 3321 is located on one side of the first engagement part 331 away from the plate body 311. A surface of the main part 3321 facing the plate body 311 is recessed away from the plate body 311 to form a second arc-shaped groove 332a. In at least one embodiment, there are two mounting parts 3322, and the two mounting parts 3322 are distributed on opposite sides of the second arc-shaped groove 332a, ensuring more stable and balanced clamping force between the main part 3321 and the plate body 311.

In at least one embodiment, as shown in FIGS. 4 and 10, the first side A of the plate body 311 may include at least one second mounting post 314. Each second mounting post 314 extends in a direction perpendicular to the plate body 311 and defines a screw hole. Each mounting part 3322 also defines a screw hole. By screwing a screw into the screw hole of the mounting part 3322 and the screw hole of the second mounting post 314, the second mounting post 314 and the mounting part 3322 can be locked and fixed, thereby fixing the second engagement part 332 to the plate body 311.

In other embodiments, the second engagement part 332 can also be fixedly connected to the plate body 311 by riveting, snapping, bonding, etc.

In at least one embodiment, the first engagement part 331 is integrally formed with the plate body 311. In other embodiments, the first engagement part 331 can be fixedly connected to the plate body 311 by screwing, riveting, snapping, bonding, etc.

In at least one embodiment, the first engagement part 331 and the second engagement part 332 can be made of abrasion-resistant polymer materials to reduce contact stress of the first engagement part 331 and the second engagement part 332 with the third shaft part 121, minimizing abrasion and extending service life. Abrasion-resistant polymer materials may include polyoxymethylene (POM).

In other embodiments, the first engagement part 331 and the second engagement part 332 can also be made of other materials.

Please refer to FIG. 11. FIG. 11 illustrates a schematic view of another partial cross-sectional structure of the viewing angle adjustment mechanism 100 as shown in FIG. 1 take along a line I-I′. FIG. 11 illustrates the connection relationship between the second connecting part 12 and the fourth connecting part 33 in at least one embodiment. In at least one embodiment, as shown in FIG. 11, the second connecting part 12 is the third shaft portion 121, and the fourth connecting part 33 may include the first engagement part 331 and the second engagement part 332. The first engagement part 331 and the second engagement part 332 cooperatively form the annular cavity 33a. The third shaft portion 121 is inserted into the annular cavity 33a and can rotate relative to the annular cavity 33a.

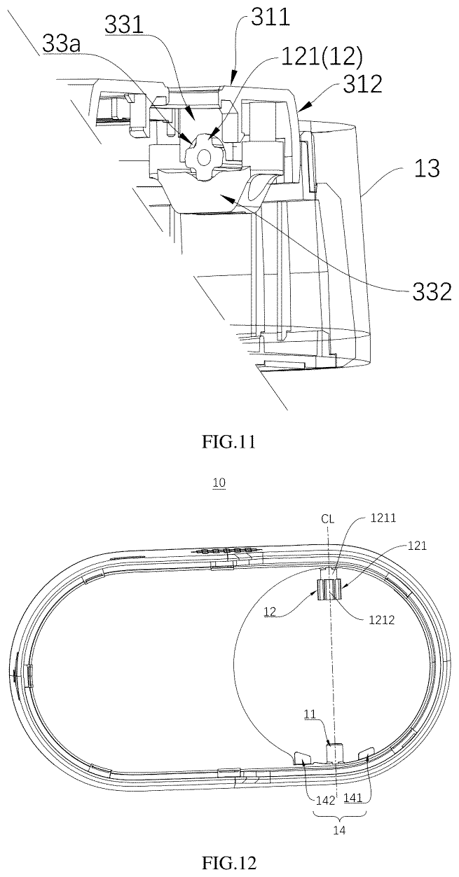

Please refer to FIGS. 9 and 12. FIG. 12 illustrates a top view of the support member 10 as shown in FIG. 1. In at least one embodiment, as shown in FIGS. 9 and 12, the third shaft portion 121 of the second connecting part 12 may include a shaft body 1211 and at least two positioning parts 1212. The at least two positioning parts 1212 are distributed along a circumference of the shaft body 1211, and each positioning part 1212 extends along the axial direction of the shaft body 1211.

In at least one embodiment, the shaft body 1211 and the at least two positioning parts 1212 are integrated. Compared to the third shaft portion 121 being cylindrical, i.e., having a peripheral surface that is a regular circle, by arranging the at least two positioning parts 1212 circumferentially on the shaft body 1211, the peripheral surface of the third shaft portion 121 is not a regular circle but rather a ring with uneven structure, which enables the molten plastic material to form multiple flow channels during injection molding, reducing the material thickness and thereby avoiding issues such as shrinkage and deformation caused by excessive material thickness during injection, thereby ensuring that the third shaft portion 121, when inserted into the annular cavity 33a, remains tightly pressed against the cavity wall of the annular cavity 33a, and further maintaining the damping force during rotation and better achieving the self-locking function. Additionally, compared to the third shaft portion 121 being cylindrical (where the entire peripheral surface of the third shaft portion 121 is in contact with the cavity wall of the annular cavity 33a), the outward-protruding positioning parts 1212 arranged circumferentially on the shaft body 1211 ensure that only the outer surfaces of the positioning parts 1212 contact the cavity wall of the annular cavity 33a, while the surfaces of the shaft body 1211 between adjacent positioning parts 1212 do not contact the cavity wall, reducing the contact area between the third shaft portion 121 and the annular cavity 33a, increasing the pressure and thereby improving the pressing effect between the cavity wall of the annular cavity 33a and the third shaft portion 121.

In at least one embodiment, as shown in FIGS. 2 to 6, the rotating body 31 may further include a side wall 312. The side wall 312 is connected to a periphery of the plate body 311. The side wall 312 is located on the first side A of the plate body 311, forming an accommodating space with the plate body 311. At least portions of the third connecting part 32 and the fourth connecting part 33 are located within the accommodating space. As shown in FIGS. 4 to 6, the side wall 312 may include a first side wall 3121 and a second side wall 3122. The first side wall 3121 is close to the second connecting part 12, and the second side wall 3122 is close to the first connecting part 11.

When the second connecting part 12 includes the third shaft portion 121 and the first connecting part 11 includes the first shaft portion 11a, the first side wall 3121 is close to the third shaft portion 121, and the second side wall 3122 is close to the first shaft portion 11a.

In at least one embodiment, as shown in FIGS. 3 and 6, part of a surface of the first side wall 3121 away from the plate body 311 is recessed toward the plate body 311 to form a first notch 3123. The second connecting part 12 includes the third shaft portion 121. The third shaft portion 121 is inserted into the first notch 3123 and the annular cavity 33a and can rotate relative to the first engagement part 331, the second engagement part 332, and the first side wall 3121.

The first notch 3123 forms an avoidance channel, allowing the third shaft portion 121 to be inserted into the annular cavity 33a along the axial direction.

In at least one embodiment, the first notch 3123 surrounds the area of the shaft body 1211 where the positioning parts 1212 are not provided.

By configuring the first notch 3123 to cooperate with the shaft body 1211, an additional rotation pivot point is effectively added, making the load distribution more balanced and improving the stability of the rotation of the rotating member 30 relative to the support member 10.

In at least one embodiment, as shown in FIGS. 4 to 6, part of a surface of the second side wall 3122 away from the plate body 311 is recessed toward the plate body 311 to form a second notch 3124. As shown in FIG. 8, the first shaft portion 11a passes through the second notch 3124 and is inserted into the first shaft hole 32a or the first groove, and can rotate relative to the third connecting part 32 and the second side wall 3122.

The second notch 3124 forms an avoidance channel, allowing the first shaft portion 11a to be inserted into the first shaft hole or the first groove along the axial direction.

By configuring the second notch 3124 to cooperate with the first shaft portion 11a, an additional rotation pivot point is effectively added, making the load distribution more balanced and further improving the stability of the rotation of the rotating member 30 relative to the support member 10.

In at least one embodiment, the second connecting part 12 is the third shaft portion 121, and the fourth connecting part 33 defines a third shaft hole or a third groove on a surface of the fourth connecting part 33 close to the support body 13. The third shaft portion 121 is inserted into the third shaft hole or the third groove and can rotate within the third shaft hole or the third groove. The third shaft portion 121 and the third shaft hole or the third groove may have a clearance fit.

In other embodiments, the second connecting part 12 is a fourth shaft hole defined on the support body 13 or a fourth groove defined on a surface of the support body 13 close to the fourth connecting part 33. The fourth connecting part 33 may include a fourth shaft portion. The fourth shaft portion is inserted into the fourth shaft hole or the fourth groove and can rotate within the fourth shaft hole or the fourth groove. The fourth shaft portion and the fourth shaft hole or the fourth groove may have a clearance fit.

In at least one embodiment, the first connecting part 11 is the first shaft portion 11a, and the third connecting part 32 may include a third engagement part and a fourth engagement part. The third engagement part and the fourth engagement part are fixedly connected to the first side A of the plate body 311. A surface of the third engagement part away from the plate body 311 is recessed toward the plate body 311 to form a third arc-shaped groove. A surface of the fourth engagement part facing the plate body 311 is recessed away from the plate body 311 to form a fourth arc-shaped groove. The fourth arc-shaped groove is located on one side of the third arc-shaped groove away from the plate body 311. Groove walls of the third arc-shaped groove and the fourth arc-shaped groove cooperatively form an annular cavity. The first shaft portion 11a is inserted into the annular cavity and can rotate relative to the third engagement part and the fourth engagement part around the axis of the first shaft portion 11a. The annular cavity may be a closed ring or an open ring. The third shaft portion 121 is in contact with the cavity wall of the annular cavity.

In at least one embodiment, as shown in FIG. 7, the support body 13 of the support member 10 may include a first cover plate 131, a second cover plate 132, and a side plate 133. The first cover plate 131 and the second cover plate 132 are arranged opposite each other, and the side plate 133 is connected between the first cover plate 131 and the second cover plate 132. The side plate 133, the first cover plate 131, and the second cover plate 132 cooperatively form an accommodating cavity 134. The first cover plate 131 defines an opening 1311, and the first connecting part 11 and the second connecting part 12 are located within the accommodating cavity 134 and close to the opening 1311. At least part of the camera structure 20 is located within the accommodating cavity 134. The third connecting part 32, the fourth connecting part 33, and the part of the side wall 312 of the rotating body 31 away from the plate body 311 extend into the accommodating cavity 134 through the opening 1311. The formed accommodating cavity 134 can provide protection for the camera structure 20.

In at least one embodiment, as shown in FIGS. 7 and 12, the support member 10 may further include a stop portion 14. The stop portion 14 is located on the support body 13. The stop portion 14 is located on a rotation path of the rotating body 31. When the rotating body 31 rotates relative to the support member 10 around the rotation center line CL to a preset position, the stop portion 14 abuts against the rotating body 31, preventing the rotating body 31 from continuing to rotate and thereby limiting the further rotation of the camera structure 20. Thus, the stop portion 14 can limit the end of the rotation path of the rotating body 31 as the rotating body 31 rotates around the rotation center line CL, thereby restricting the rotation angle of the rotating body 31 relative to the support member 10 and limiting the rotation angle of the camera structure 20 relative to the support member 10.

By providing the stop portion 14, excessive rotation of the rotating member 30 can be avoided, preventing the camera structure 20 or other components on the first side A of the plate body 311 from being exposed, which could affect aesthetics. Additionally, by providing the stop portion 14, issues such as poor shooting angles caused by excessive rotation of the camera structure 20 can be avoided.

In at least one embodiment, a projection of the stop portion 14 on a plane of the plate body 311 partially overlaps with a projection of the side wall 312 on the plane of the plate body 311. When the side wall 312 rotates around the rotation center line CL, the side wall 312 will abut against the stop portion 14 and cannot continue rotating in the same direction.

In at least one embodiment, as shown in FIGS. 7 and 12, the stop portion 14 may include a first stop portion 141 and a second stop portion 142. The first stop portion 141 and the second stop portion 142 are located on opposite sides of the rotation center line CL. The preset position includes a first preset position and a second preset position. When the rotating body 31 rotates relative to the support member 10 in a first rotation direction (as shown by the R1 direction in FIG. 7) to the first preset position, the first stop portion 141 abuts against the rotating body 31 to prevent further rotation in the first rotation direction. When the rotating body 31 rotates relative to the support member 10 in a second rotation direction (as shown by the R2 direction in FIG. 7) to the second preset position, the second stop portion 142 abuts against the rotating body 311 to prevent further rotation in the second rotation direction. The second rotation direction is opposite to the first rotation direction.

By positioning the first stop portion 141 and the second stop portion 142 on opposite sides of the rotation center line CL, when the rotating body 31 rotates in opposite directions, the exposure of the camera structure 20 or other components on the first side A of the plate body 311 can be avoided, and issues such as poor shooting angles caused by excessive rotation of the second camera structure 20 can be avoided.

In at least one embodiment, the projection of the first stop portion 141 on the plane of the plate body 311 partially overlaps with the projection of the side wall 312 on the plane of the plate body 311. When the side wall 312 rotates around the rotation center line CL in the first rotation direction, the side wall 312 will abut against the first stop portion 141 and cannot continue rotating in the first rotation direction.

In at least one embodiment, the projection of the second stop portion 142 on the plane of the plate body 311 partially overlaps with the projection of the side wall 312 on the plane of the plate body 311. When the side wall 312 rotates around the rotation center line CL in the second rotation direction, the side wall 312 will abut against the second stop portion 142 and cannot continue rotating in the second rotation direction.

In at least one embodiment, when the rotating body 31 rotates to a third preset position, the large surface of the plate body 311 is parallel to the large surface of the second cover plate 132. The large surface of the second cover plate 132 refers to the surface with the largest area of the second cover plate 132.

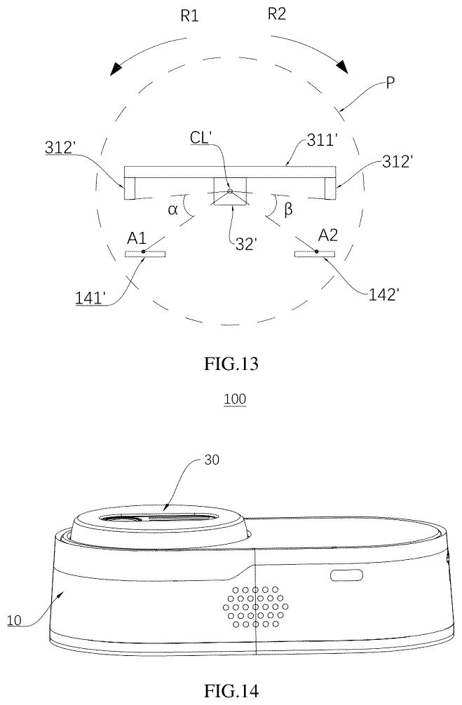

Please refer to FIG. 13. FIG. 13 illustrates a schematic view of projections of a first stop portion 141, a second stop portion 142, a rotation center line CL, a plate body 311, a side wall 312, and a third connecting part 32 on a rotation plane P in at least one embodiment of the present disclosure. FIG. 13 illustrates the projections of the plate body 311, the side wall 312, and the third connecting part 32 on the rotation plane P when the rotating body 31 is rotated to the third preset position. The rotation plane P is perpendicular to the rotation center line CL.

In at least one embodiment, as shown in FIG. 13, the projection of the first stop portion 141 on the rotation plane P is a first projection 141′, the projection of the second stop portion 142 on the rotation plane P is a second projection 142′, the projection of the rotation center line CL on the rotation plane P is a third projection CL′, the projection of the plate body 311 on the rotation plane P when rotated to the third preset position is a fourth projection 311′, the projection of the side wall 312 on the rotation plane P when rotated to the third preset position is a fifth projection 312′, and the projection of the third connecting part 32 on the rotation plane P when rotated to the third preset position is a sixth projection 32′.

When the rotating body 31 is rotated to the first preset position, the side wall 312 abuts against a first area of the first stop portion 141. The projection of the first area on the rotation plane P is a seventh projection A1 (as shown in FIG. 13). An angle between the line connecting the end of the fifth projection 312′ close to the first projection 141′ and the third projection CL′ and the line connecting the seventh projection A1 and the third projection CL′ is a first angle α. Thus, when the rotating body 31 rotates from the third preset position in the first rotation direction, the maximum rotation angle of the rotating body 31 is the first angle α, meaning the maximum rotation angle of the camera structure 20 is the first angle α. At this point, the rotating body 31 is rotated to the first preset position.

When the rotating body 31 is rotated to the second preset position, the side wall 312 abuts against a second area of the second stop portion 142. The projection of the second area on the rotation plane P is an eighth projection A2 (as shown in FIG. 13). The angle between the line connecting the end of the fifth projection 312′ close to the second projection 142′ and the third projection CL′ and the line connecting the eighth projection A2 and the third projection CL′ is a second angle β. Thus, when the rotating body 31 rotates from the third preset position in the second rotation direction, the maximum rotation angle of the rotating body 31 is the second angle β, meaning the maximum rotation angle of the camera structure 20 is the second angle β. At this point, the rotating body 31 is rotated to the second preset position.

Therefore, by adjusting the first angle α and the second angle β, the maximum rotation angle of the rotating member 30 in the first rotation direction and the maximum rotation angle in the second rotation direction can be adjusted.

The first angle α and the second angle β may be equal or unequal.

In at least one embodiment, the first angle α and the second angle β are greater than or equal to 10° and less than or equal to 15°. In other embodiments, the first angle α and the second angle β may be other angle values.

In at least one embodiment, the first stop portion 141 and the second stop portion 142 are both close to the first connecting part 11 and located on opposite sides of the first connecting part 11 (as shown in FIGS. 7 and 12). That is, the distance between the first stop portion 141 and the first connecting part 11 is smaller than the distance between the first stop portion 141 and the second connecting part 12, the distance between the second stop portion 142 and the first connecting part 11 is smaller than the distance between the second stop portion 142 and the second connecting part 12. Alternatively, the first stop portion 141 and the second stop portion 142 are both adjacent to the second connecting part 12 and located on opposite sides of the second connecting part 12. That is, the distance between the first stop portion 141 and the second connecting part 12 is smaller than the distance between the first stop portion 141 and the first connecting part 11, and the distance between the second stop portion 142 and the second connecting part 12 is smaller than the distance between the second stop portion 142 and the first connecting part 11. In other embodiments, one of the first stop portion 141 and the second stop portion 142 is adjacent to the first connecting part 11, and the other of the first stop portion 141 and the second stop portion 142 is adjacent to the second connecting part 12, with the first stop portion 141 and the second stop portion 142 located on opposite sides of the rotation center line of the first connecting part 11 and the second connecting part 12.

In at least one embodiment, the stop portion 14 may include a third stop portion and/or a fourth stop portion (not shown in the figures). The first stop portion 141 and the second stop portion 142 are both close to one of the first connecting part 11 and the second connecting part 12, and the third stop portion and/or the fourth stop portion are both close to the other of the first connecting part 11 and the second connecting part 12. When the stop portion 14 includes the third stop portion and the fourth stop portion, the third stop portion and the fourth stop portion are located on opposite sides of the rotation center line CL.

Please refer to FIGS. 14 and 15. FIG. 14 illustrates a schematic structural view of the viewing angle adjustment mechanism 100 as shown in FIG. 1 from second view. FIG. 15 illustrates a schematic structural view of the viewing angle adjustment mechanism 100 as shown in FIG. 1 from third view. FIG. 14 illustrates a state of the viewing angle adjustment structure 100 when the rotating member 30 is in the third preset position, and FIG. 15 illustrates a state of the viewing angle adjustment structure 100 when the rotating member 30 is rotated in the first rotation direction to the first preset position.

In at least one embodiment, as shown in FIGS. 1 to 3 and 6, the plate body 311 defines a through hole 311a. An imaging acquisition end 21 of the camera structure 20 faces the through hole 311a, allowing the camera structure 20 to capture images through the through hole 311a.

The imaging acquisition end 21 may refer to the end of the camera structure 20 where the optical lens is located. The imaging acquisition end 21 is configured to focus light rays onto an image sensor of the camera structure 20, enabling the image sensor to generate image signals based on the light signals and transmit the image signals to the image processor. The image processor processes the image signals to generate the final image.

In at least one embodiment, the viewing angle adjustment structure 100 may further include a driving assembly (not shown in the figures). The driving assembly is connected to the third connecting part 32 and/or the fourth connecting part 33. The driving assembly is configured to drive the third connecting part 32 and the fourth connecting part 33 to rotate relative to the support member 10 around the rotation center line CL, thereby driving the rotating body 31 and the camera structure 20 to rotate relative to the support member 10 around the rotation center line CL. Thus, the viewing angle adjustment structure 100 can intelligently and automatically adjust the viewing angle of the camera structure 20.

In at least one embodiment, the driving assembly may include a motor. An output shaft of the motor is fixedly connected to the third connecting part 32 or the fourth connecting part 33. When the motor operates, the output shaft drives the third connecting part 32 or the fourth connecting part 33 to rotate relative to the support member 10, thereby driving the rotating body 31 and the camera structure 20 to rotate relative to the support member 10. A housing of the motor can be fixed to the support member 10, which provides support for the motor.

In at least one embodiment, the driving assembly may include two motors. The output shaft of one motor is fixedly connected to the third connecting part 32, and the output shaft of the other motor is fixedly connected to the fourth connecting part 33. When the two motors operate, their output shafts work at the same speed and synchronously drive the third connecting part 32 and the fourth connecting part 33 to rotate relative to the support member 10, thereby driving the rotating body 31 and the camera structure 20 to rotate relative to the support member 10.

The output shaft of the motor can be directly connected to the third connecting part 32 or the fourth connecting part 33, or connected via a reduction device. The reduction device may include a gear reducer, a worm gear reducer, etc.

In at least one embodiment, the driving assembly may include a cylinder assembly and a transmission assembly. The transmission assembly is connected to the cylinder assembly and the first connecting part 11 or The transmission assembly is connected to the cylinder assembly and the third connecting part 32. The transmission assembly converts the linear motion of the cylinder assembly into rotational motion, driving the first connecting part 11 or the third connecting part 32 to rotate relative to the support member 10, thereby driving the rotating body 31 and the camera structure 20 to rotate relative to the support member 10. The transmission assembly may include a crank-slider mechanism, a gear-rack mechanism, a sprocket-chain mechanism, a non-return yoke mechanism, etc.

In other embodiments, the driving assembly may be other types of driving devices, as long as it can drive the third connecting part 32 and/or the fourth connecting part 33 to rotate relative to the support member 10.

In at least one embodiment, the viewing angle adjustment structure 100 may further include an interaction module and a processor (not shown in the figures). The interaction module is configured for users to perform viewing angle adjustment operations, and the processor is configured to control the driving assembly to drive the third connecting part 32 and the fourth connecting part 33 to rotate relative to the support member 10 around the rotation center line CL in response to the user's operations of viewing angle adjustment applied on the interaction module.

The interaction module may include a touch screen, mechanical buttons, etc. For example, when the interaction module is a touch screen, the touch screen has a rotation angle setting interface. The processor is configured to obtain the target rotation angle input by the user on the rotation angle setting interface and control the driving assembly to drive the third connecting part 32 and the fourth connecting part 33 to rotate relative to the support member 10 around the rotation center line CL by the target rotation angle. When the interaction module includes multiple mechanical buttons, each mechanical button corresponds to a different rotation angle. The processor is configured to determine the target rotation angle in response to the user's pressing of the mechanical buttons and control the driving assembly to drive the third connecting part 32 and the fourth connecting part 33 to rotate relative to the support member 10 around the rotation center line CL by the target rotation angle.

In the embodiments of the present disclosure, the fixed connection may be a detachable fixed connection or a non-detachable fixed connection.

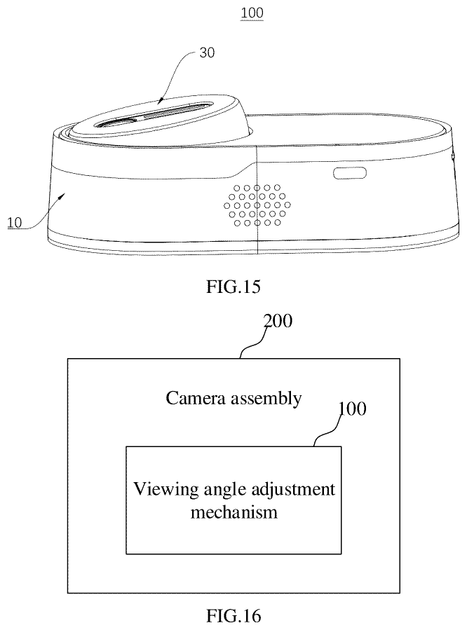

Please refer to FIG. 16. FIG. 16 illustrates a structural block view of the camera assembly in accordance with at least one embodiment of the present disclosure. As shown in FIG. 16, the camera assembly 200 may include the viewing angle adjustment structure 100 described in any of the preceding embodiments.

The camera assembly 200 may include one or more camera structures 20.

The camera assembly 200 may further include the image processor. Alternatively, the image processor may be integrated into the camera structure 20.

In at least one embodiment, the camera assembly 200 may further include a battery, a charging port, a card slot, a microphone, a speaker, etc.

The camera assembly 200 can be applied in various scenarios, including photography, videography, medical imaging, machine vision, security, automotive electronics, drones, medical devices, etc.

In at least one embodiment, the camera assembly 200 can be fixedly mounted on a carrier. The carrier may be transparent or opaque.

In at least one embodiment, the camera assembly 200 is fixedly mounted on a first side of the carrier and is configured to image objects on the first side and/or a second side of the carrier. The first side and the second side of the carrier are opposite each other.

In at least one embodiment, the camera assembly 200 may further include a connecting member. The connecting member is connected between the support member 10 and the first side of the carrier, such as between the second cover plate 132 and the first side of the carrier.

In at least one embodiment, the connecting member may include at least one of hook-and-loop fasteners, adhesive, negative pressure structural members, or magnetic members.

In at least one embodiment, the connecting member may include a first connecting member and a second connecting member stacked along a direction perpendicular to the second cover plate 132. One side of the first connecting member away from the second connecting member is connected to the second cover plate 132, and one side of the second connecting member away from the first connecting member is connected to the first side of the carrier.

In at least one embodiment, the first connecting member may include one of a hook surface or a loop surface of the hook-and-loop fastener, and the second connecting member may include the other of the hook surface or the loop surface of the hook-and-loop fastener. The side of the first connecting member facing the second cover plate 132 is tightly bonded to the second cover plate 132 with adhesive, and pressure is applied to ensure the adhesive fully bonds, securing the first connecting member firmly to the second cover plate 132. Similarly, the side of the second connecting member facing the carrier is adhered to the first side of the carrier with adhesive, and pressure is applied to ensure the second connecting member is firmly attached to the carrier. Then, the assembled camera assembly 200 is brought close to the carrier.

The side of the first connecting member facing the second connecting member is one of the hook surface or the loop surface, and the side of the second connecting member facing the first connecting member is the other of the hook surface or the loop surface. Thus, by applying appropriate pressure, the hook surface and the loop surface fully engage, the camera assembly 200 is securely mounted on the carrier.

When disassembly is needed, the first connecting member and the second connecting member are separated by pulling apart the hook and loop surfaces, allowing the camera assembly 200 to be removed from the carrier.

In other embodiments, when both the first connecting member and the second connecting member are hook-and-loop fasteners, they can be fixed to the second cover plate 132 and the first side of the carrier in other ways, such as by screwing or riveting.

In at least one embodiment, the first connecting member may include a first magnetic member, and the second connecting member may include a second magnetic member. The first magnetic member and the second magnetic member are opposite poles of magnets and can attract each other. The first magnetic member is fixed to the second cover plate 132, and the second magnetic member is fixed to the carrier. During mounting, under magnetic force, the two opposite poles automatically attract each other, aligning precisely and adhering tightly to complete the mounting. During disassembly, the first magnetic member and the second magnetic member are separated along a direction perpendicular to the magnetic force.

Additionally, with mounting methods such as hook-and-loop fasteners or magnetic attraction, if the camera assembly 200 is found to be misaligned on the carrier, there is no need to laboriously peel off adhesive and damage the bonding surface. Instead, the connection between the first connecting member and the second connecting member can be separated, the position of the camera assembly 200 adjusted to align the camera structure 20 at the proper angle, and then reattached.

In at least one embodiment, the connecting member may include adhesive, such as double-sided tape or glue. Adhesive may be applied to corresponding positions on the second cover plate 132 and the carrier. The second cover plate 132 and the carrier are aligned and pressed together with appropriate pressure to complete the mounting of the camera assembly 200. For disassembly, a specialized solvent may be used to dissolve or weaken the adhesive, allowing the second cover plate 132 to be separated from the carrier.

In at least one embodiment, the connecting member may include a negative pressure structural member, such as a silicone suction cup. During mounting, the suction cup is aligned with the carrier and pressed firmly to ensure tight contact with the first side without gaps. As air is gradually expelled, a negative pressure forms between the connecting member and the carrier, and under atmospheric pressure, the suction cup adheres tightly to the carrier, stably mounting the camera assembly 200. For disassembly, external air can be introduced to balance the pressure, and once the negative pressure dissipates, the suction cup can be separated from the carrier to remove the camera assembly 200.

With negative pressure adsorption installation, if the camera assembly 200 is misaligned on the carrier, there is no need to peel off adhesive. Instead, the connection between the suction cup and the carrier can be separated, the camera assembly 200 re-positioned to align the camera structure 20 at the proper angle, and then reattached.

The mounting methods of the camera assembly 200 onto the carrier include but are not limited to hook-and-loop fasteners, magnetic attraction, adhesive, and negative pressure adsorption. The mounting method may be configured based on actual conditions and is not specifically limited here.

In the above embodiments, the description of each embodiment has its own focus. For parts not detailed in a particular embodiment, may be made to the relevant descriptions in other embodiments.

The above describes the implementation of the embodiments of the present disclosure. It should be noted that, for those of ordinary skill in the technical field, without departing from the principles of the embodiments of the present disclosure, several improvements and refinements may be made, and such improvements and refinements shall also be regarded as within the protection scope of the present disclosure.

What is claimed is:

1. A viewing angle adjustment mechanism, wherein the viewing angle adjustment mechanism comprises:
a support member comprising a first connecting part and a second connecting part apart from each other;
a camera structure; and,
a rotating member comprising a rotating body, a third connecting part and a fourth connecting part;
wherein the third connecting part and the fourth connecting part are located on the rotating body separately, the third connecting part is rotatably connected to the first connecting part, the fourth connecting part is rotatably connected to the second connecting part; a rotation center line of the first connecting part and the third connecting part coincides with a rotation center line of the second connecting part and the fourth connecting part;
wherein the camera structure is fixedly connected to the rotating body;
wherein a rotation of the rotating body relative to the support member drives the camera structure to rotate relative to the support member, to change a viewing angle of the camera structure.

2. The viewing angle adjustment mechanism according to claim 1, wherein: the rotating body comprises a plate body, the third connecting part and the fourth connecting part are located on a first side of the plate body along a thickness direction of the plate body; the camera structure is located on the first side of the plate body and is fixedly connected to the plate body; a surface of a second side of the plate body is configured to be pressed to rotate the plate body relative to the support member, thereby driving the camera structure to rotate relative to the support member; the second side is opposite to the first side.

3. The viewing angle adjustment mechanism according to claim 2, wherein: the support member comprises a support body; the first connecting part comprises a first shaft portion located on the support body; the third connecting part defines a first shaft hole or defines a first groove on a surface of the third connecting part close to the support body; the first shaft portion is inserted into the first shaft hole or the first groove;
or,
the first connecting part is a second shaft hole defined on the support body or a second groove defined on a surface of support body close to the third connecting part; the third connecting part comprises the second shaft portion, and the second shaft portion is inserted into the second shaft hole or the second groove.

4. The viewing angle adjustment mechanism according to claim 2, wherein: the support member comprises a support body, the second connecting part comprises a third shaft portion located on the support body; the fourth connecting part comprises a first engagement part and a second engagement part; the first engagement part and the second engagement part are connected to the first side of the plate body; a surface of the first engagement part away from the plate body is recessed toward the plate body to form a first arc-shaped groove; a surface of the second engagement part facing the plate body is recessed away from the plate body to form a second arc-shaped groove; the second arc-shaped groove is located on one side of the first arc-shaped groove away from the plate body; groove walls of the first arc-shaped groove and the second arc-shaped groove cooperatively form an annular cavity; the third shaft portion is inserted into the annular cavity and can rotate relative to the first engagement part and the second engagement part around an axis of the third shaft portion.

5. The viewing angle adjustment mechanism according to claim 4, wherein: the third shaft portion of the second connecting part comprises a shaft body and at least two positioning parts; the at least two positioning parts are distributed along a circumference of the shaft body, and each positioning part extends along an axial direction of the shaft body.

6. The viewing angle adjustment mechanism according to claim 4, wherein: the rotating body further comprises a side wall, the side wall is connected to a periphery of the plate body, the side wall is located on the first side of the plate body, forming an accommodating space with the plate body; at least portions of the first connecting part and the third connecting part are located within the accommodating space; the side wall comprises a first side wall close to the third shaft portion, part of a surface of the first side wall facing away from the plate body is recessed toward the plate body to form a first notch; the third shaft portion is inserted into the first notch and the annular cavity and can rotate relative to the first engagement part, the second engagement part, and the first side wall.

7. The viewing angle adjustment mechanism according to claim 2, wherein: the rotating body further comprises a side wall, the side wall is connected to a periphery of the plate body, the side wall is located on the first side of the plate body, forming an accommodating space with the plate body; at least portions of the first connecting part and the third connecting part are located within the accommodating space; the side wall comprises a second side wall close to the first shaft portion, part of a surface of the second side wall facing away from the plate body is recessed toward the plate body to form a second notch; the first shaft portion passes through the second notch and is inserted into the first shaft hole or the first groove, and can rotate relative to the third connecting part and the second side wall.

8. The viewing angle adjustment mechanism according to claim 1, wherein: the support member further comprises a support body and a stop portion; the stop portion, the first connecting part and the second connecting part are located on the support body; the stop portion is located on a rotation path of the rotating body; when the rotating body rotates relative to the support member around the rotation center line to a preset position, the stop portion abuts against the rotating body, preventing the rotating body from continuing to rotate and thereby limiting further rotation of the camera structure.

9. The viewing angle adjustment mechanism according to claim 8, wherein: the stop portion comprises a first stop portion and a second stop portion; the first stop portion and the second stop portion are located on opposite sides of the rotation center line; the preset positions comprises a first preset position and a second preset position; when the rotating body rotates relative to the support member in a first rotation direction to the first preset position, the first stop portion abuts against the rotating body to prevent further rotation in the first rotation direction; when the rotating body rotates relative to the support member in a second rotation direction to the second preset position, the second stop portion abuts against the rotating body to prevent further rotation in the second rotation direction, the second rotation direction is opposite to the first rotation direction.

10. The viewing angle adjustment mechanism according to claim 2, wherein: the plate body defines a through hole; an imaging acquisition end of the camera structure faces the through hole, allowing the camera structure to capture images through the through hole.

11. The viewing angle adjustment mechanism according to claim 2, wherein: the support member comprises a support body, the support body of the support member comprises a side plate, a first cover plate and a second cover plate, the first cover plate and the second cover plate are arranged opposite to each other, and the side plate is connected between the first cover plate and the second cover plate; the side plate, the first cover plate, and the second cover plate cooperatively form an accommodating cavity; the first cover plate defines an opening, and the first connecting part and the second connecting part are located within the accommodating cavity and close to the opening; at least part of the camera structure is located within the accommodating cavity; the third connecting part and the fourth connecting part extend into the accommodating cavity through the opening.

12. The viewing angle adjustment mechanism according to claim 1, wherein: the viewing angle adjustment mechanism comprises a driving assembly; the driving assembly is connected to the third connecting part and/or the fourth connecting part;
the driving assembly is configured to drive the third connecting part and the fourth connecting part to rotate relative to the support member around the rotation center line, thereby driving the rotating body and the camera structure to rotate relative to the support member around the rotation center line.

13. A camera assembly, wherein: the camera assembly comprises a viewing angle adjustment mechanism according to claim 1.
